(19) United States
(12) Patent Application Publication
(10) Pub. No.: US 2025/0330093 A1
(43) Pub. Date: Oct. 23, 2025

(54) SIMO CONVERTER INCLUDING TRANSIENT ENHANCEMENT LOOP

(71) Applicant: Microchip Technology Inc., Chandler, AZ (US)

(72) Inventor: Sanjana Karadi Shanmukhappa, Gilbert, AZ (US)

(73) Assignee: Microchip Technology Inc., Chandler, AZ (US)

(21) Appl. No.: 18/767,640

(22) Filed: Jul. 9, 2024

Related U.S. Application Data
(60) Provisional application No. 63/637,781, filed on Apr. 23, 2024.

(51) Int. Cl. H02M 3/158; H02M 1/32

(52) U.S. Cl. CPC H02M 3/1584; H02M 1/32

(57) ABSTRACT

A single inductor multiple output (SIMO) converter includes an inductor, a plurality of output switches, and a transient enhancement loop (TEL). The inductor includes an input terminal and an output terminal. A plurality of output switches may include respective input terminals and output terminals. The input terminals may be electrically connected to the inductor output terminal. The output terminals may be electrically connected to respective loads. The TEL includes a code generator and a plurality of current sources. The code generator may detect a load transient event and activate at least one of the current sources. The current sources include respective source transistors and sink transistor electrically connected to respective output terminals of the output switches. The source transistors may be electrically connected to a source voltage. The sink transistors may be electrically connected to a ground terminal.

### CROSS-REFERENCE TO RELATED APPLICATIONS

The current patent application claims the benefit under 35 U.S.C. § 119 (e) of the priority date of U.S. Provisional Application Ser. No. 63/637,781; titled “UNDERSHOOT AND OVERSHOOT REDUCTION DURING LOAD TRANSIENT IN SINGLE INDUCTOR MULTIPLE OUTPUT BUCK CONVERTER”; and filed Apr. 23, 2024. The Provisional Application is hereby incorporated by reference, in its entirety, into the current patent application.

### TECHNICAL FIELD

Various examples of the present disclosure relate to devices and techniques for reducing undershoot and overshoot during load transient events in a single inductor multiple output (SIMO) converter.

### BACKGROUND

Single inductor multiple output (SIMO) converters are commonly implemented in small electronic devices including Internet-of-Things (IoT) devices, wearable devices, smart devices, or DC/DC converters. However, existing SIMO converters are susceptible to voltage undershoot, overshoot, and cross-regulation between loads.

This background discussion is intended to provide information related to the present invention which is not necessarily prior art.

### SUMMARY OF THE INVENTION

According to various examples of the present disclosure, a single inductor multiple output (SIMO) converter is provided. The SIMO converter may include an inductor, a plurality of output switches, and a transient enhancement loop (TEL). The inductor may include an inductor input terminal and an inductor output terminal. The plurality of output switches may include respective input terminals and respective output terminals. The respective input terminals of the plurality of output switches may be electrically connected to the inductor output terminal. The output terminals of the plurality of output switches may be electrically connected to corresponding ones of a plurality of loads. The TEL may include a code generator and a plurality of current sources. The code generator may detect a load transient event associated with one or more of the loads and activate at least one of the plurality of current sources. The plurality of current sources may include respective source transistors and respective sink transistors electrically connected between respective ones of the output terminals of the plurality of output switches and corresponding ones of the plurality of loads. The respective source transistors may be electrically connected to a source voltage. The respective sink transistors may be electrically connected to a ground terminal.

According to various examples of the present disclosure, a transient enhancement loop (TEL) circuit is provided. The TEL circuit includes one or more input terminals, a plurality of output terminals, a code generator, and a plurality of current sources. The one or more input terminals may receive a plurality of reference voltages and a plurality of respective feedback voltages. The plurality of output terminals may be electrically connected to corresponding ones of a plurality of loads. The feedback voltages may respectively correspond to output voltages supplied to the plurality of loads. The code generator may include a plurality of comparators. The plurality of comparators may compare respective ones of the plurality of reference voltages to corresponding ones of the plurality of feedback voltages, detect a load transient event associated with one or more of the loads based on the comparison, and generate a code indicative of the load transient event. One or more of the plurality of current sources may compensate for a load variation condition caused by the load transient event. The plurality of current sources may respectively include respective source transistors and respective sink transistors electrically connected between respective ones of the output terminals of the plurality of output switches and corresponding ones of the plurality of loads. The respective source transistors may be electrically connected to a source voltage and supply additional current to corresponding ones of the plurality of loads. The respective sink transistors may be electrically connected to a ground terminal and reduce an amount of current supplied to corresponding ones of the plurality of loads.

According to various examples of the present disclosure, a method for operating a single inductor multiple output (SIMO) converter is provided. A plurality of output voltages between a plurality of output switches and corresponding loads connected to respective output terminals of the plurality of switches are sampled by a transient enhancement loop (TEL). The output terminals may be electrically connected to a plurality of corresponding loads. The TEL may detect a load transient event associated with one or more of the loads. A code generator of the TEL may generate a code indicative of the transient event. At least one of a plurality of current sources of the TEL may be activated based on the code. The plurality of current sources may include respective source transistors and respective sink transistors electrically connected between respective ones of the output terminals of the plurality of output switches and corresponding ones of the plurality of loads. The respective source transistors may be electrically connected to a source voltage. The respective sink transistors may be electrically connected to a ground terminal.

### BRIEF DESCRIPTION OF THE DRAWINGS

FIG. 1 illustrates an example single inductor multiple output (SIMO) converter including a transient enhancement loop (TEL) in accordance with the present disclosure;

FIG. 2 illustrates an example TEL of the SIMO converter of FIG. 1;

FIG. 3 illustrates example current sources of the TEL of the SIMO converter of FIG. 1;

FIGS. 4A and 4B illustrate an example code generator of the TEL of the SIMO converter of FIG. 1; and

FIG. 5 illustrates an example method performed by the SIMO converter of FIG. 1.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

Various examples of the present disclosure relate to devices and techniques for reducing voltage undershoot and overshoot during load transient events in a single inductor multiple output (SIMO) converter. A transient enhancement loop (TEL) monitors or samples voltages levels at outputs of the SIMO converter. Additionally, the TEL may control a plurality of current sources for providing additional electrical power at an output of the SIMO converter if a voltage droop or undershoot is detected at the output, or reducing an amount of electrical power at an output if voltage overshoot is detected at the output. The TEL may accordingly provide or reduce electrical power respectively at the multiple outputs simultaneously, in stages, or otherwise in response to instances or events experienced at the same or at different times across the multiple outputs, within the scope of the present disclosure and as described in more detail below. In various examples, the plurality of current sources and corresponding TEL components may address load transient events of one of the output switches and one of the loads, without departing from the scope of the disclosure.

Advantageously, various examples of the present disclosure enhance a load transient response of the SIMO converter. In this disclosure, a load transient event may refer to any sudden change in a load current or voltage, such as when a load is activated, deactivated, initially connected to the SIMO, or has a sudden change in current draw, without limitation. In various examples, the load transient response may refer to a response of the SIMO converter during a load transient event to compensate for load variation conditions associated with the load transient event. A slow load transient response may be lead to voltage undershoot, voltage overshoot, or cross-regulation, without limitation, across the loads powered by the SIMO converter. Cross-regulation across the loads may cause damage due to improper voltages being applied to the loads.

In various examples, the SIMO converter may include an inductor, a plurality of output switches, and a TEL. The TEL may be operable to reduce unwanted effects of load variation conditions, including overshoot, undershoot, and cross-regulation, without limitation. The load variation conditions may be associated with load transient events across the outputs of the SIMO converter. The reduced overshoot, undershoot, and cross-regulation may ensure proper operating voltages are supplied to each of the loads, which may prevent damage caused by improper operating voltages and may extend a device lifespan.

The TEL may determine occurrence of a load transient event in part by monitoring or sampling a voltage at an output, where the monitored or sampled voltage or an electrical signal indicative of that voltage is referred to herein as a “feedback voltage.” The feedback voltage may be compared to a reference voltage at a comparator, with the output of the comparator representing a determination of whether the load transient event is occurring or has been detected. The reference voltage may represent a threshold for determining whether and to what extent, for example, voltage overshoot or undershoot is occurring at the output.

As will be explained in more detail below, a plurality of comparators, informing operation of or otherwise interoperating with a plurality of corresponding current sources, may receive and compare the same feedback voltage against different reference voltages, respectively determining voltage overshoot or undershoot in varying degrees for the output at a given moment in time. Further, the comparators may perform their operations for the output on multiple feedback voltages monitored or sampled across time, and each output may have its own respective corresponding one or more comparators and one or more current sources for evaluating its own potential load transient event(s), in each case as discussed in more detail below. In various examples, the comparators may include digital components, such as integrated circuit(s) and digital signal processor(s), analog circuitry, or both digital components and analog circuitry, without departing from the scope of the present disclosure.

More particularly, the TEL may include a plurality of comparators and a plurality of current sources. The plurality of current sources may include respective source transistors and sink transistors. The source transistors may provide additional electrical power to corresponding loads. The sink transistors may reduce an amount of electrical power supplied to corresponding loads. In various examples, the output switches may receive electrical energy from the inductor and, when closed, supply respective output voltages to corresponding loads. The TEL may measure or sample the respective output voltages. A plurality of feedback voltages may correspond to respective ones of the sampled or measured output voltages. The TEL may receive a plurality of reference voltages. The reference voltages may correspond to thresholds for activating respective source and sink transistors of the TEL. Respective ones of the plurality of comparators may compare one of the feedback voltages with one of the respective reference voltages and generate a code indicating whether a load transient event is detected. The code from one of the comparators may activate or deactivate a corresponding transistor. More specifically, if undershoot is detected by a comparator, a corresponding source transistor may be activated. If overshoot is detected by another comparator, a corresponding sink transistor may be activated.

In various examples, respective ones of the current sources may be electrically connected between one of the output switches and one of the loads. Respective ones of the current sources may include a plurality of source transistors and plurality of sink transistors. Respective ones of the comparators may correspond to the plurality of source transistors. Respective ones of the comparators may correspond to the plurality of sink transistors. Respective source transistors of a first current source may be activated sequentially by the comparators when voltage undershoot is detected, for example with the activated source transistors being activated based on different threshold reference voltages. The activated source transistors may be sequentially deactivated when undershoot is no longer detected. On the other hand, respective sink transistors of the first current source may be activated sequentially by the comparators when voltage overshoot is detected, for example with the activated sink transistors being activated based on different threshold reference voltages. The respective activated sink transistors may be sequentially deactivated when overshoot is no longer detected.

In various examples, the SIMO converter may be implemented in various small form factor low power electronic devices, such as Internet-of-Things (IoT) devices, wearable devices, smart devices, or DC/DC converters, without limitation.

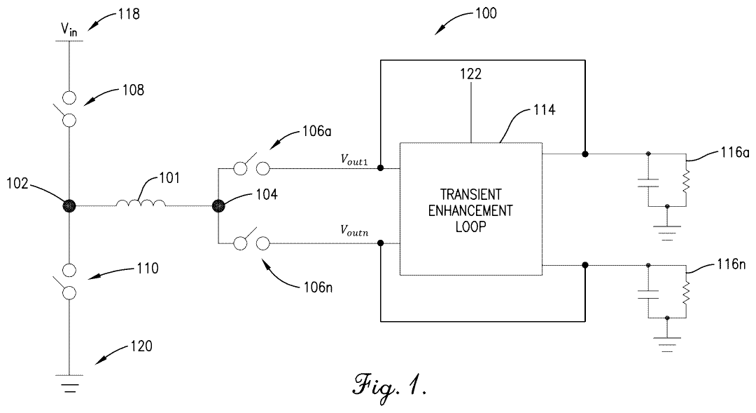

FIG. 1 illustrates a single inductor multiple output (SIMO) converter 100 according to various examples of the present disclosure. The SIMO converter 100 may be operable to receive electrical power from a supply voltage terminal 118 and provide electrical power to loads 116a, . . . , 116n. The SIMO converter 100 includes a high-side switch 108, a low-side switch 110, an inductor 101, a plurality of output switches 106a, . . . , 106n, and a transient enhancement loop (TEL) 114. The inductor 101 may include an inductor input terminal 102 and an inductor output terminal 104. In various examples, the number n may correspond to a number of output switches included in the SIMO converter 100 and the output switch 106n may represent a second output switch, a third switch, and so on.

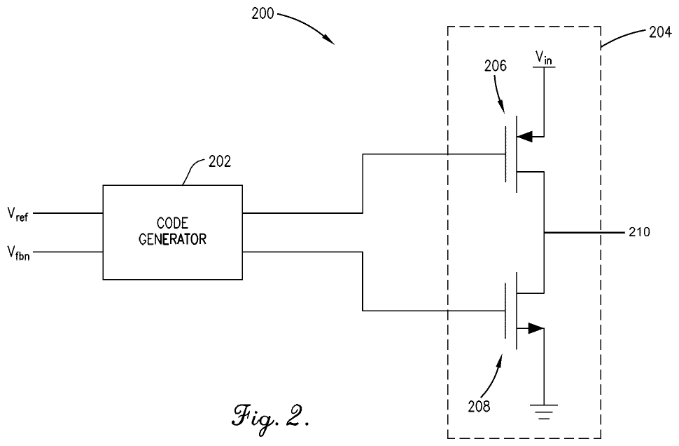

In various examples, the supply voltage terminal 118 may apply a source voltage Vᵢₙ to the inductor 101 via the high-side switch 108. The inductor 101 may provide a first output voltage Vₒᵤₜ₁ to the first output switch 106a and an nth output voltage Vₒᵤₜₙ to the output switch 106n via the inductor output terminal 104. The output voltages Vₒᵤₜ₁, . . . , Vₒᵤₜₙ may be respectively used to power the loads 116a, . . . , 116n. The TEL 114 may include a code generator and a plurality of current sources, which are discussed below with reference to FIGS. 2, 3, 4A, and 4B. In various examples, the TEL 114 may be operable to monitor or sample the output voltages Vₒᵤₜ₁, . . . , Vₒᵤₜₙ and activate one or more of the current sources of the TEL 114 based on respective comparisons of the output voltages Vₒᵤₜ₁, . . . , Vₒᵤₜₙ with corresponding ones of a plurality of reference voltages V_{ref}.

The high-side switch 108 and the low-side switch 110 may control charging and discharging of the inductor 101. The high-side switch 108 may be electrically connected between the supply voltage terminal 118 and the inductor input terminal 102. The supply voltage terminal 118 may supply the source voltage Vᵢₙ to the high-side switch 108. The low-side switch 110 may be electrically connected between the inductor input terminal 102 and a ground terminal 120. In one or more examples, the high-side switch 108 and the low-side switch 110 may be operated such that when the high-side switch 108 is open, the low-side switch 110 is closed, and vice-versa. When closed, the high-side switch 108 may connect the supply voltage terminal 118 to the inductor input terminal 102, causing the inductor 101 to begin charging. When closed, the low-side switch SW_{LS} may be operable to connect the inductor input terminal 102 to the ground terminal 120, causing the inductor 101 to discharge electrical energy.

As described above, in various examples, the inductor input terminal 102 may be electrically connected between the high-side switch 108 and the low-side switch 110. When connected to the supply voltage terminal 118, via the high-side switch 108, the inductor 101 may begin charging and store electrical energy. When connected to the ground terminal 120 via the low-side switch 110, the inductor 110 may discharge the stored electrical energy. The inductor 101 may provide discharged electrical energy to one or more of the output switches 106a, . . . , 106n for supplying electrical power to the corresponding loads 116a, . . . , 116n. The discharged electrical energy may correspond to one or more of the output voltages Vₒᵤₜ₁, . . . , Vₒᵤₜₙ and may be used to power one or more of the loads 116a, . . . , 116n.

In various examples, first and second ones of the output switches 106a, . . . , 106n may be electrically connected between the inductor output terminal 104 and corresponding first and second ones of the loads 116a, . . . , 116n, such that the output switches 106a, . . . , 106n respectively control the flow of electrical energy to corresponding ones of the loads 116a, . . . , 116n. In various examples, the output switch 106a may be electrically connected between the inductor output terminal 104 and the load 116a. When the output switch 116a is closed, electrical energy received from the inductor 101, corresponding to the output voltage Vₒᵤₜ₁, may be provided to the load 116a. In various examples, the output switch 106n may be connected between the inductor output terminal 104 and the load 116n. When the output switch 106n is closed, electrical energy received from the inductor 101, corresponding to the output voltage Vₒᵤₜₙ, may be provided to the load 116n.

It would be appreciated by one of ordinary skill in the art that each load 116a, . . . , 116n may be associated with an amount of power drawn by one or more devices connected to corresponding ones of the output switches 106a, . . . , 106n. Although the loads 116a, . . . , 116n are shown as RC circuits including a resistor and a capacitor, the loads 116a, . . . , 116n may correspond to various types of devices receiving power from the SIMO converter 100, such as electronic components of low voltage electric devices including wearable devices, IoT devices, headphones, earbuds, smart watches, field programmable gate arrays (FPGAs), programmable logic devices, (PLDs), and integrated circuits (ICs), without limitation. In various examples, the SIMO converter 100 is shown to be electrically connected to at least two loads 116a, . . . , 116n. It would be appreciated by one of ordinary skill in the art that the SIMO converter 100 may supply power to any number of loads and therefore incorporate a corresponding number of output switches. Correspondingly, the number of loads to be powered by the SIMO converter 100 may correspond to a number of output switches electrically connected to the inductor 101.

In various examples, the SIMO converter 100 is shown to have at least two (2) output switches 106a, . . . , 106n. It would be appreciated by one of ordinary skill in the art that the SIMO converter 100 may include any number of output switches. In various examples, three (3), four (4), five (5), six (6), seven (7), eight (8), nine (9), ten (10), eleven (11), twelve (12), or more output switches may be provided, without limitation. In various examples, the number of output switches may be related to a power rating of the SIMO converter 100.

In various examples, a load transient event may occur when one or more of the loads 116a, . . . , 116n are activated or have a sudden change in current draw. The load transient event may cause one or more load variation conditions, such as voltage overshoot, voltage undershoot, or cross-regulation. One or more of the load variation conditions, such as voltage undershoot or cross-regulation, may be associated with a voltage droop across output(s) of one or more of the output switches 106a, . . . , 106n. The voltage droop may be due to an amount of electrical energy drawn by one or more of the loads 116a, . . . , 116n being greater than an amount of electrical energy supplied to the loads 116a, . . . , 116n by the inductor 101. Consequentially, voltage droop may cause damaging conditions in the loads 116a, . . . , 116n, such as performance degradation, limited energy efficiency, and clock timing failures.

In various examples, the TEL 114 may be electrically connected to the output switches 106a, . . . , 106n. The TEL 114 may monitor the output voltages Vₒᵤₜ₁, . . . , Vₒᵤₜₙ from the output switches 106a, . . . , 106n. In various examples, the TEL 114 may activate one or more of the current sources based on detecting a load transient event associated with one or more of the loads 116a, . . . , 116n. In various examples, the TEL 114 may monitor the output voltages Vₒᵤₜ₁, . . . , Vₒᵤₜₙ by measuring or sampling respective voltage levels of the output voltages Vₒᵤₜ₁, . . . , Vₒᵤₜₙ. The measured or sampled respective voltage levels of the output voltages Vₒᵤₜ₁, . . . , Vₒᵤₜₙ may correspond to respective feedback voltages V_{fb1}, . . . , V_{fbn}. In various examples, the TEL 114 may monitor the output voltages Vₒᵤₜ₁, . . . , Vₒᵤₜₙ continuously, periodically, or within one or more time periods associated with a switching frequency of one or more of the output switches 106a, . . . , 106n, without limitation. In various examples, the feedback voltages V_{fb1}, . . . , V_{fbn} may be representative of the output voltages Vₒᵤₜ₁, . . . , Vₒᵤₜₙ and may be generated by the TEL 114. In various examples, the feedback voltages V_{fb1}, . . . , V_{fbn} may be measured or sampled voltage levels of the output voltages Vₒᵤₜ₁, . . . , Vₒᵤₜₙ.

In various examples, the TEL 114 may include one or more input terminals 122 for receiving the reference voltages V_{ref}. The TEL 114 may detect a load transient event associated with one or more of the output voltages Vₒᵤₜ₁, . . . , Vₒᵤₜₙ by comparing the respective reference voltage(s) V_{ref} with the corresponding feedback voltages V_{fb1}, . . . , V_{fbn}. If a result of the comparison indicates that one of the feedback voltages V_{fb1}, . . . , V_{fbn} is greater or lesser than a corresponding one of the reference voltages V_{ref}, the load transient event may be detected. The code generator of the TEL 114 may generate a code indicating or because the load transient event is detected. One or more of the current sources may be activated upon receiving the code. The current source(s) may supply additional electrical energy to one or more of the loads 116a, . . . , 116n to compensate for voltage undershoot or reduce an amount of electrical energy supplied to one or more of the loads 116a, . . . , 116n to compensate for voltage overshoot. In various examples, the current sources include respective source transistors and sink transistors to shape a current supplied to the plurality of loads. Shaping the current may efficiently compensate for voltage undershoot, voltage overshoot, and cross-regulation associated with load transient events by ensuring a proper amount of current is supplied to each load.

FIG. 2 illustrates an example TEL 200 according to the present disclosure. In various examples, the TEL 200 may be implemented in a SIMO converter, such as the SIMO converter 100. In various examples, the TEL 200 may correspond to the TEL 114 described with reference to FIG. 1. The TEL 200 may include a code generator 202 and a current source 204. In various examples, the current source 204 may include a source transistor 206 and a sink transistor 208 electrically connected to the code generator 202 and the output terminal 210. The source transistor 206 may be electrically connected to a source voltage Vᵢₙ. The sink transistor 208 may be electrically connected to a ground terminal. The source transistor 206 may provide electrical current to the output terminal 210. The sink transistor 208 may reduce an amount of current supplied to the output terminal 210.

The output terminal 210 may be electrically connected between a corresponding output switch and a load, such as output switch 106a and load 116a of FIG. 1. The output switch may supply an output voltage Vₒᵤₜₙ to the load. In various examples, the output terminal 210 of the current source 204 may be electrically connected between an output terminal of the output switch and the load. The current source 204 may supply additional current to the load or may reduce an amount of current supplied to the load, depending on whether undershoot or overshoot is detected, for example. In various examples, the source transistor 206 may be activated by the code generator 202 to compensate for voltage undershoot, or other undervoltage conditions. The sink transistor 208 may be activated by the code generator 202 to compensate for voltage overshoot, or other overvoltage conditions.

The code generator 202 may receive a first reference voltage V_{ref1}, a second reference voltage V_{ref2}, and a feedback voltage V_{fbn}. The feedback voltage V_{fbn} may correspond to the output voltage Vₒᵤₜₙ. In various examples, the feedback voltage V_{fbn} may be representative of a measured or sampled voltage value of the output voltage Vₒᵤₜₙ. In various examples, the feedback voltage V_{fbn} may be the output voltage Vₒᵤₜₙ. In various examples, the first and second reference voltages V_{ref1}, V_{ref2} may correspond to respective threshold voltage levels for activating the source transistor 206 and the sink transistor 208.

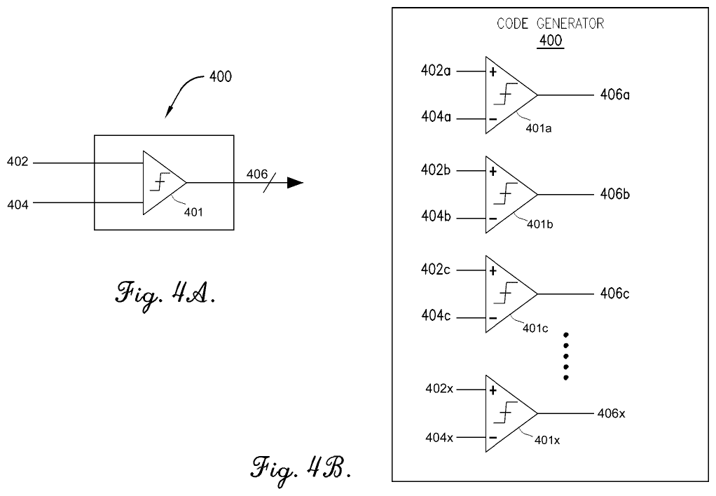

The code generator 202 may include first and second comparators, such as the comparators 401a and 401b (shown in FIG. 4B). The first and second comparators may be electrically connected to respective gate terminals of the source transistor 206 and the sink transistor 208. The first comparator may compare the first reference voltage V_{ref1} and the feedback voltage V_{fbn}. The second comparator may compare the second reference voltage V_{ref2} and the feedback voltage V_{fbn}. The first comparator may generate a code to activate the source transistor 206 if the first reference voltage V_{ref1} is greater than the feedback voltage V_{fbn}. The first comparator may generate a code to deactivate the activated source transistor 206 if the first reference voltage V_{ref1} is less than a second, later-sampled feedback voltage. Alternatively, the second comparator may generate a code to activate the sink transistor 206 if the second reference voltage V_{ref2} is less than the feedback voltage V_{fbn}. The second comparator may generate a code to deactivate the activated sink transistor 208 if the second reference voltage V_{ref2} is greater than a second, later-sampled feedback voltage.

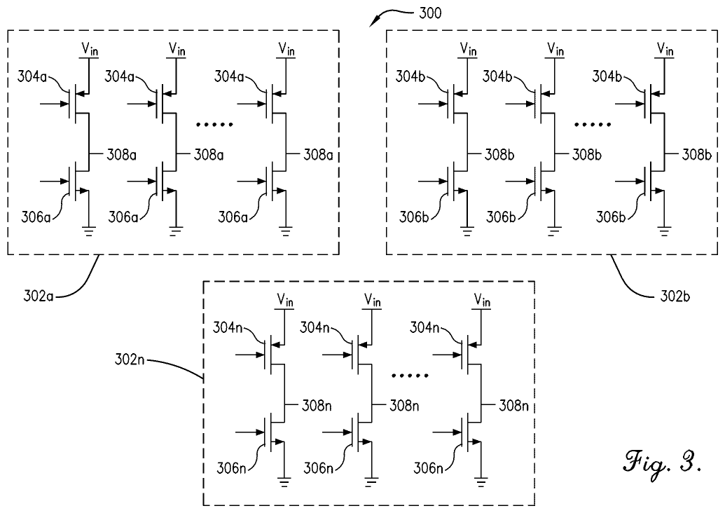

For ease of simplicity, only one current source 204 is shown in FIG. 2. It would be appreciated by one of ordinary skill in the art that a TEL may include a plurality of current sources, for example as shown in FIG. 3 and discussed below. In various examples, the current source 204 may include a plurality of source transistors 206 and a plurality of sink transistors 208, also as described in reference to FIG. 3.

FIG. 3 illustrates example current sources 300 of the TEL 114 of the SIMO converter 100 of FIG. 1. The current sources 300 may include current sources 302a, 302b, . . . 302n. In various examples, the current sources 300 may include any number of current sources and may directly correspond to a number of output switches included in the SIMO converter 100. The current source 302a may include a plurality of source transistors 304a, a plurality of sink transistors 306a, and a plurality of output terminals 308a. The current source 302b may include a plurality of source transistors 304b, a plurality of sink transistors 306b, and a plurality of output terminals 308b. The current source 302n may include a plurality of source transistors 304n, a plurality of sink transistors 306n, and a plurality of output terminals 308n.

In various examples, the source transistors 304a, 304b, . . . , 304n, and the sink transistors 306a, 306b, . . . , 306n may be p-type transistors and n-type transistors, respectively. In various examples, the source transistors 304a, 304b, . . . , 304n may be n-type transistors and the sink transistors 306a, 306b, . . . , 306n may be p-type transistors. In various examples, the source transistors 304a, 304b, . . . , 304n and the sink transistors 306a, 306b, . . . , 306n may be n-type transistors. In various examples, the source transistors 304a, 304b, . . . , 304n and the sink transistors 306a, 306b, . . . , 306n may be p-type transistors. The p-type transistors may be p-channel metal-oxide-semiconductor (PMOS) transistors. The n-type transistors may be n-channel metal-oxide-semiconductor (NMOS) transistors.

In various examples, the source transistors 304a, 304b, . . . , 304n, and the sink transistors 306a, 306b, . . . , 306n may be respectively connected to corresponding comparators of a plurality of comparators. In various examples, the plurality of comparators may be included in a code generator, such as the code generator 202 discussed with reference to FIG. 2 and a code generator 400, discussed with reference to FIGS. 4A and 4B, without limitation. The source transistors 304a, 304b, . . . , 304n and the sink transistors 306a, 306b, . . . , 306n may receive one or more codes from the plurality of comparators. The code(s) may activate or deactivate individual source transistors 304a, 304b, . . . , 304n and individual sink transistors 306a, 306b, . . . , 306n to compensate for load variation conditions caused by load transient events.

In various examples, the output terminals 308a, 308b, . . . , 308n may be electrically connected between respective output switches and loads to be powered by the output switches. The output switches may be the output switches 106a, . . . , 106n discussed with reference to FIG. 1, without limitation. The source transistors 304a, 304b, . . . , 304n may be activated to increase an amount of current supplied to the loads via the respective output terminals 308a, 308b, . . . , 308n. The source transistors 304a, 304b, . . . , 304n may be activated to compensate for voltage undershoot, or other undervoltage conditions, detected by the plurality of comparators. The sink transistors 306a, 306b, . . . , 306n may be activated to reduce an amount of current supplied to the loads via the output terminals 308a, 308b, . . . , 308n. The sink transistors 306a, 306b, . . . , 306n may compensate for voltage overshoot, or other overvoltage conditions, detected by the plurality of comparators.

In various examples, the output terminal 308a of current source 302a may be electrically connected between a first output switch and a first load. The first output switch may supply a first output voltage to the first load. In various examples, a load transient event associated with the first output voltage may be detected by a code generator, such as the code generator 202 (shown in FIG. 2) or a code generator 400 (shown in FIGS. 4A and 4B). The source transistors 304a of the current source 302a may be activated sequentially when the load transient event is indicative of voltage undershoot or other undervoltage conditions. The sink transistors 306a may be activated sequentially when the load transient event is indicative of voltage overshoot or other overvoltage conditions.

In various examples, multiple source transistors (for example, source transistors 304a) are activated simultaneously where the thresholds for droop represented by corresponding reference voltages V_{ref} are satisfied by a given feedback voltage V_{fb}. Similarly, in various examples, multiple sink transistors (for example, sink transistors 306a) are activated simultaneously where the thresholds for overshoot represented by corresponding reference voltages V_{ref} are satisfied by a given feedback voltage V_{fb}. However, advantageously, examples of the present disclosure also provide for cascading or sequenced activation, responsive to dynamic load transient events and varying voltage thresholds, as discussed in more detail below.

In various examples, a first of the source transistors 304a may initially be activated at a first time TO when undershoot is detected corresponding to a first threshold reference voltage applied by the corresponding first comparator. If undershoot is still detected at a second time T1, after activating the first source transistor 304a, and the corresponding feedback voltage at T1 satisfies a second threshold reference voltage applied by the corresponding second comparator, a second of the source transistors 304a may be activated. In various examples, the second threshold reference voltage is lower, and therefore representative of a more significant droop event, than the first threshold reference voltage. In various other examples, the second threshold reference voltage level is higher, and therefore representative of a less significant droop event, than the first threshold reference voltage. Remaining source transistors 304a may have similarly staggered threshold reference voltages, providing for cascading and sequenced activation in response to dynamic load transient undershoot events.

Correspondingly, undershoot at the level of the second threshold reference voltage may no longer be detected at a time T3 and the second of the source transistors 304a may accordingly be deactivated. Further, undershoot at the level of the first threshold reference voltage may no longer be detected at a time T4 and the first of the source transistors 304a may accordingly be deactivated. In this manner, the source transistors 304a may be sequentially activated in response to corresponding changes in feedback voltages relative to corresponding threshold reference voltages, and deactivated responsive to subsiding of the load transient event as evidenced by later feedback voltages. In view of the discussion above, the source transistors 304a may be sequentially deactivated in a reverse order with respect to an order in which the source transistors 304a were activated during the event, such that a most recently activated source transistor 304a may be deactivated first and so on and so forth. In various other examples, the source transistors 304a may be sequentially deactivated in the same order in which they were activated, such that the first of the source transistors 304a may also be deactivated first.

In various examples, a first of the sink transistors 306a may initially be activated at a first time TO when overshoot is detected corresponding to a first threshold reference voltage applied by the corresponding first comparator. In various examples, the first of the sink transistors 306a may be associated with a different load than the source transistors 304a in the above example. The first of the sink transistors 306a may be activated simultaneously with the first of the source transistors 304a or during a different load transient event. The different load transient event may occur before or after the droop event described in the above example. If overshoot is still detected at a second time T1, after activating the first sink transistor 306a, and the corresponding feedback voltage at T1 satisfies a second threshold reference voltage applied by the corresponding second comparator, a second of the sink transistors 306a may be activated. In various examples, the second threshold reference voltage is higher, and therefore representative of a more significant overvoltage event, than the first threshold reference voltage. In various other examples, the second threshold reference voltage level is lower, and therefore representative of a less significant overvoltage event, than the first threshold reference voltage. Remaining sink transistors 306a may have similarly staggered threshold reference voltages, providing for cascading and sequenced activation in response to dynamic load transient overshoot events.

Correspondingly, overshoot at the level of the second threshold reference voltage may no longer be detected at a time T3 and the second of the sink transistors 306a may accordingly be deactivated. Further, overshoot at the level of the first threshold reference voltage may no longer be detected at a time T4 and the first of the sink transistors 306a may accordingly be deactivated. In this manner, the sink transistors 306a may be sequentially activated in response to corresponding changes in feedback voltages relative to corresponding threshold reference voltages, and deactivated responsive to subsiding of the load transient event as evidenced by later feedback voltages. In view of the discussion above, the sink transistors 306a may be sequentially deactivated in a reverse order with respect to an order in which the sink transistors 306a were activated during the event, such that a most recently activated sink transistor 306a may be deactivated first and so on and so forth. In various other examples, the sink transistors 306a may be sequentially deactivated in the same order in which they were activated, such that the first of the sink transistors 306a may also be deactivated first.

In various examples, the source transistors 304b, . . . , 304n and sink transistors 306b, . . . , 306n of the current sources 302b, . . . , 302n may be activated and deactivated in the same manner as described with respect to the current source 302a, including, for example, responsive to one or more other load transient events experienced by one or more other loads. Of course, it should also be appreciated that the current sources 302a, 302b, . . . , 302n may activate or deactivate according to different sequences within the same SIMO within the scope of the present disclosure.

In various examples, the load transient event may be associated with cross-regulation. Cross-regulation may occur between loads connected to the output switches and the output terminals 308a, 308b, . . . 308n, such that one load connected to a first output switch, may cause voltage undershoot or overshoot at other loads. Voltage undershoot or overshoot at any of the loads may be harmful to the respective loads and may cause performance degradation, damage to internal circuitry, and other unwanted effects. In various examples, a combination of source transistors 304a, 304b, . . . , 304n and sink transistors 306a, 306b, . . . , 306n may be sequentially activated to shape a current provided to the respective output terminals 308a, 308b, . . . , 308n to compensate for voltage undershoot and overshoot caused by cross-regulation between the loads. Accordingly, the current sources 300 may compensate for voltage undershoot without overcompensating and potentially causing damaging overvoltage conditions, and vice-versa.

FIGS. 4A and 4B illustrate an example code generator 400 of the TEL 114 of the SIMO converter 100 of FIG. 1. The code generator 400 may include comparators 401, input terminals 402, 404, and output terminals 406. In various examples, the code generator 400 may include a number x of input terminals 402, input terminals 404, comparators 401, and output terminals 406. The number x may correspond to a number of transistors included in the current sources of the TEL, for example where the number x of comparators 401 equals the number of transistors of the TEL. In various examples, the comparators 401 may include comparators 401a, 401b, 401c, . . . , 401x. The comparators 401a, 401b, 401c, . . . , 401x may respectively include input terminals 402a, 402b, 402c, . . . , 402x (FIG. 4B) corresponding to the input terminals 402 (FIG. 4A). The comparators 401a, 401b, 401c, . . . , 401x may respectively include input terminals 404a, 404b, 404c, . . . , 404x (FIG. 4B) corresponding to the input terminals 404 (FIG. 4A). The comparators 401a, 401b, 401c, . . . , 401x may respectively include output terminals 406a, 406b, 406c, . . . , 404x (FIG. 4B) corresponding to the output terminals 406 (FIG. 4A).

In various examples, the SIMO converter 100 may include any number of output switches, as described above with reference to FIG. 1. The TEL 400 may include a number of current sources corresponding to the number of output switches. Accordingly, for a respective output switch, the code generator 400 may include a number of comparators 401 corresponding to a number of transistors included in a current source electrically connected to the respective output switch. More specifically, a first subset of comparators 401 may correspond to respective source transistors of a first current source, such as the current source 302a described with reference to FIG. 3. A second subset of comparators 401 may correspond to respective sink transistors of the first current source. A third subset of comparators may correspond to respective source transistors of a second current source, such as the current source 302b described with reference to FIG. 3, and so on.

The first subset of comparators may respectively receive a first feedback signal or voltage associated with a first output switch and varying reference signals associated with different thresholds, such that the corresponding source transistors may be activated sequentially to shape a current provided to a first load if the first feedback voltage signals undershoot. The second subset of comparators may respectively receive the first feedback signal or voltage and varying reference signals associated with different thresholds, such that corresponding sink transistors may be activated sequentially to shape a current provided to the first load if the first feedback voltage signals overshoot. The third subset of comparators may respectively receive a second feedback signal or voltage associated with a second output switch and varying reference signals associated with different thresholds, such that the corresponding source transistors may be activated sequentially to shape a current provided to a load if the second feedback voltage signals overshoot, and so on.

More specifically, in various examples, the comparator 401a may receive a first feedback voltage V_{fb1} at the input terminal 402a and a first reference voltage V_{ref1} at the input terminal 404a. The first feedback voltage V_{fb1} may correspond to or be a first output voltage supplied to a first load. The first output voltage may be sampled or measured between the first output switch and the first load to generate the first feedback voltage V_{fb1}. The first output switch may be one of the output switches 106a, . . . , 106n described with reference to FIG. 1. In various examples, the first reference voltage V_{ref1} may correspond to a first threshold value for the first feedback voltage V_{fb1}.

In various examples, the first threshold value may be a first undershoot threshold. If the comparator 401a determines that the first feedback voltage V_{fb1} is less than the first reference voltage V_{ref1}, undershoot may be detected. If undershoot is detected, the comparator 401a may generate a code for activating a first source transistor (for example, a first one of the source transistors 304a) electrically connected between the first output switch and the first load.

The comparator 401b may receive a second feedback voltage V_{fb2} at the input terminal 402b and a second reference voltage V_{ref2} at the input terminal 404b. In various examples, the second feedback voltage V_{fb2} may correspond to or be a second output voltage supplied to the first load. In various examples, the second feedback voltage V_{fb2} may be identical to the first feedback voltage V_{fb1}, particularly if sampled simultaneously.

In various examples, the second reference voltage V_{ref2} may be a second undershoot threshold. In various examples, the second threshold value may be associated with a lower voltage level than the first threshold value. If the comparator 401b determines that the second feedback voltage V_{fb2} is less than the second reference voltage V_{ref2}, undershoot may be detected. If undershoot is detected, the comparator 401b may generate an output for activating a second source transistor (for example, a second one of the source transistors 304a) electrically connected between the first output switch and the first load. In various examples, a plurality of source transistors electrically connected between the first output switch and the first load may be sequentially activated by corresponding comparators in the manner described with reference to the comparators 401a and 401b until undershoot is no longer detected.

In various examples, the comparator 401c may receive a third feedback voltage V_{fb3} at the input terminal 402c and a third reference voltage V_{ref3} at the input terminal 404c. In various examples, the third feedback voltage V_{fb3} may correspond to or be a third output voltage supplied to the first load. In various examples, the third feedback voltage V_{fb3} may be identical to the first feedback voltage V_{fb1}, particularly if sampled simultaneously. In various examples, the third reference voltage V_{ref3} may correspond to a third threshold value for the third feedback voltage V_{fb3}.

In various examples, the third threshold value may be an overshoot threshold. If the comparator 401c determines that the third feedback voltage V_{fb3} is greater than the third reference voltage V_{ref3}, overshoot may be detected. If overshoot is detected, the comparator 401c may generate an output for activating a first sink transistor (for example, a first of sink transistors 306a) electrically connected between the first output switch and the first load. In various examples, a plurality of sink transistors electrically connected between the first output switch and the first load may be sequentially activated by corresponding comparators in the manner described with reference to the comparators 401c until overshoot is no longer detected. One or more source transistors and one or more sink transistors electrically connected between other output switches and other loads may also be associated with corresponding comparators, and may operate to correct for undershoot and overshoot events in the manner described above.

In various examples, the comparator 401x may receive a feedback voltage V_{fbn} at the input terminal 402x and a corresponding reference voltage V_{ref} at the input terminal 404x. In various examples, the feedback voltage V_{fbn} may correspond to an output voltage supplied to an nth load by an nth output switch. The nth output switch may be the output switch 106n. The nth load may be the load 116n. In various examples, the reference voltage V_{ref} may be an overshoot threshold for the feedback voltage V_{fbn}. The comparator 401x may detect voltage overshoot by determining that the feedback voltage V_{fbn} is greater than the reference voltage V_{ref}. If overshoot is detected, the comparator 401x may generate an output for activating an “xth” sink transistor electrically connected between the nth output switch and the nth load. In various examples, a plurality of sink transistors electrically connected between the nth output switch and the nth load may be sequentially activated by corresponding comparators until overshoot is no longer detected.

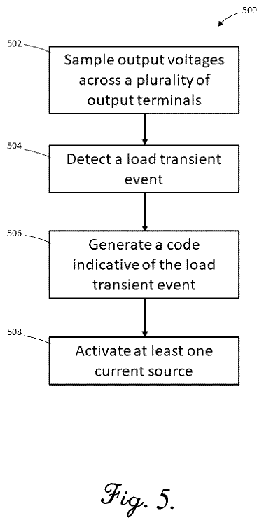

FIG. 5 illustrates an example method 500 performed by a SIMO converter, such as the SIMO converter 100 of FIG. 1. At operation 502, a transient enhancement loop (TEL) may sample a plurality of output voltages supplied to a plurality of loads by corresponding output switches. The output switches may be respectively electrically connected to corresponding ones of the loads. The TEL may correspond to the TEL 114 or the TEL 200, without limitation.

At operation 504, the TEL may detect a load transient event associated with one or more of the loads. The TEL may receive respective reference voltages. The respective reference voltages may correspond to various threshold voltage levels and may be used to detect voltage overshoot or undershoot. The TEL may generate or otherwise detect or pass along respective feedback voltages from or comprising the sampled output voltages. The feedback voltages may be generated by connecting respective input terminals of the TEL between a plurality of output switches and a plurality of corresponding loads receiving electrical power from the plurality of output switches.

At operation 506, a code generator may generate a code indicative of the transient event. The code generator may be included in the TEL. The code generator may include a plurality of comparators, such as the comparators 401 of FIG. 4B. The comparators may compare the respective feedback voltages and corresponding ones of the reference voltages. One or more of the comparators may generate the code based on the comparison. Individual comparators may generate individual codes for respective source and sink transistors of a plurality of current sources included in the TEL. The code may comprise the individual codes of the comparators generated based on a comparison of feedback voltages to reference voltages.

At operation 508, at least one of the plurality of current sources may be activated based on the code or codes. The current sources may be included in the TEL. The current sources may include source transistors and sink transistors electrically connected between respective output switches and corresponding loads. The source transistors may be electrically connected to a source voltage. The sink transistors may be electrically connected to a ground terminal. The source transistors of corresponding current sources may be sequentially activated based on the code(s). The sink transistors of corresponding current sources may be sequentially activated based on the code(s). In various examples, the source transistors may be sequentially deactivated when the corresponding load transient event is no longer detected. The sink transistors may be sequentially deactivated when the corresponding load transient event is no longer detected. The source or sink transistors may be deactivated in a reverse order in which they were activated for any given load transient event. In various examples, the source or sink transistors may be deactivated in the same order in which they were activated.

According to various examples of the present disclosure, a single inductor multiple output (SIMO) converter is provided. The SIMO converter may include an inductor, a plurality of output switches, and a transient enhancement loop (TEL). The inductor may include an inductor input terminal and an inductor output terminal. The plurality of output switches may include respective input terminals and respective output terminals. The respective input terminals of the plurality of output switches may be electrically connected to the inductor output terminal. The output terminals of the plurality of output switches may be electrically connected to corresponding ones of a plurality of loads. The TEL may include a code generator and a plurality of current sources. The code generator may detect a load transient event associated with one or more of the loads and activate at least one of the plurality of current sources. The plurality of current sources may include respective source transistors and respective sink transistors electrically connected between respective ones of the output terminals of the plurality of output switches and corresponding ones of the plurality of loads. The respective source transistors may be electrically connected to a source voltage. The respective sink transistors may be electrically connected to a ground terminal.

In combination with any of the above examples, the SIMO converter may include a first input switch and a second input switch. The first and second input switches may be electrically connected to the inductor. The first input switch may connect the inductor to a supply voltage. The second input switch may connect the inductor to ground.

In combination with any of the above examples, the source transistors may respectively supply additional current to corresponding ones of the plurality of loads. The sink transistors may respectively reduce an amount of current supplied to corresponding ones of the plurality of loads.

In combination with any of the above examples, the TEL may sample output voltages a between the output terminals of the plurality of output switches and corresponding ones of the plurality of loads and generate corresponding feedback voltages from the sampled output voltages. The code generator may include a plurality of comparators to respectively receive a feedback voltage of the feedback voltages and a corresponding reference voltage.

In combination with any of the above examples, the plurality of comparators may respectively compare the corresponding received feedback voltage and the corresponding reference voltage and, based on the comparison, generate a code indicative of the transient event.

In combination with any of the above examples, at least one of the plurality of current sources may compensate for a load variation condition associated with the load transient event. At least one of the source transistors and sink transistors of at least one of the plurality of sources may receive the code and activate based on the transient event.

In combination with any of the above examples, the load variation condition may include at least one of voltage overshoot, voltage undershoot, or cross-regulation.

In combination with any of the above examples, the plurality of comparators may correspond respectively to the plurality of current sources. The plurality of comparators may be respectively electrically connected to gate terminals of the source transistors and sink transistors of the plurality of current sources. The plurality of current sources may compensate for a load variation condition associated with the load transient event. The source transistors and sink transistors of at least one of the plurality of current sources may receive the code. The code may be indicative of the transient event.

In combination with any of the above examples, the load variation condition may be voltage overshoot. The code may sequentially activate the sink transistors of corresponding ones of the plurality of current sources.

In combination with any of the above examples, the load variation condition may be voltage undershoot. The code may sequentially activate the source transistors of corresponding ones of the plurality of current sources.

In combination with any of the above examples, the load variation condition may be cross-regulation. The code may sequentially activate the source transistors of corresponding ones of the plurality of current sources and sequentially activate the sink transistors of corresponding ones of the plurality of current sources.

According to various examples of the present disclosure, a transient enhancement loop (TEL) circuit is provided. The TEL circuit includes one or more input terminals, a plurality of output terminals, a code generator, and a plurality of current sources. The one or more input terminals may receive a plurality of reference voltages and a plurality of respective feedback voltages. The plurality of output terminals may be electrically connected to corresponding ones of a plurality of loads. The feedback voltages may respectively correspond to output voltages supplied to the plurality of loads. The code generator may include a plurality of comparators. The plurality of comparators may compare respective ones of the plurality of reference voltages to corresponding ones of the plurality of feedback voltages, detect a load transient event associated with one or more of the loads based on the comparison, and generate a code indicative of the load transient event. One or more of the plurality of current sources may compensate for a load variation condition caused by the load transient event. The plurality of current sources may respectively include respective source transistors and respective sink transistors electrically connected between respective ones of the output terminals of the plurality of output switches and corresponding ones of the plurality of loads. The respective source transistors may be electrically connected to a source voltage and supply additional current to corresponding ones of the plurality of loads. The respective sink transistors may be electrically connected to a ground terminal and reduce an amount of current supplied to corresponding ones of the plurality of loads.

In combination with any of the above examples, the plurality of comparators may correspond respectively to the plurality of current sources. The plurality of comparators may be respectively electrically connected to respective gate terminals of the corresponding source transistors and sink transistors. The source transistors and sink transistors of at least one of the plurality of current sources may receive the code. The code may be indicative of the transient event.

In combination with any of the above examples, the load variation condition may be voltage overshoot. The code may sequentially activate the sink transistors of corresponding ones of the plurality of current sources.

In combination with any of the above examples, the load variation condition may be voltage undershoot. The code may sequentially activate the source transistors of corresponding ones of the plurality of current sources.

In combination with any of the above examples, the load variation condition may be cross-regulation. The code may sequentially activate the source transistors of corresponding ones of the plurality of current sources and sequentially activate the sink transistors of corresponding ones of the plurality of current sources.

According to various examples of the present disclosure, a method for operating a single inductor multiple output (SIMO) converter is provided. A plurality of output voltages between a plurality of output switches and corresponding loads connected to respective output terminals of the plurality of switches are sampled by a transient enhancement loop (TEL).

The output terminals may be electrically connected to a plurality of corresponding loads. The TEL may detect a load transient event associated with one or more of the loads. A code generator of the TEL may generate a code indicative of the transient event. At least one of a plurality of current sources of the TEL may be activated based on the code. The plurality of current sources may include respective source transistors and respective sink transistors electrically connected between respective ones of the output terminals of the plurality of output switches and corresponding ones of the plurality of loads. The respective source transistors may be electrically connected to a source voltage. The respective sink transistors may be electrically connected to a ground terminal.

In combination with any of the above examples, detecting, by the TEL, the transient event may include receiving, by the TEL, respective reference voltages and generating, by the TEL, respective feedback voltages from the sampled output voltages,

In combination with any of the above examples, generating, by the code generator of the TEL, the code may include comparing, by a plurality of comparators of the code generator, the respective feedback voltages and respective reference voltages and generating, by the plurality of comparators, the code based on the comparison.

In combination with any of the above examples, activating the plurality of current sources of the TEL may include sequentially activating, based on the code, the source transistors of corresponding ones of the plurality of current sources and sequentially activating, based on the code, the sink transistors of corresponding ones of the plurality of current sources.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventors.

What is claimed is:

1. A single inductor multiple output (SIMO) converter comprising:
an inductor having an inductor input terminal and an inductor output terminal;
a plurality of output switches including respective input terminals and respective output terminals, said respective input terminals of the plurality of output switches being electrically connected to the inductor output terminal, said output terminals of the plurality of output switches being electrically connected to corresponding ones of a plurality of loads; and
a transient enhancement loop (TEL), said TEL including a code generator and a plurality of current sources, said code generator to detect a load transient event associated with one or more of the loads and activate at least one of the plurality of current sources,
said plurality of current sources including respective source transistors and respective sink transistors electrically connected between respective ones of the output terminals of the plurality of output switches and corresponding ones of the plurality of loads, said respective source transistors being electrically connected to a source voltage, said respective sink transistors being electrically connected to a ground terminal.

2. The SIMO converter of claim 1, comprising
a first input switch electrically connected to the inductor, said first input switch to connect the inductor to a supply voltage terminal,
a second input switch electrically connected to the inductor, said second input switch to connect the inductor to a ground terminal.

3. The SIMO converter of claim 1,
said source transistors respectively to supply additional current to corresponding ones of the plurality of loads,
said sink transistors respectively to reduce an amount of current supplied to corresponding ones of the plurality of loads.

4. The SIMO converter of claim 1,
said TEL to sample output voltages between the output terminals of the plurality of output switches and corresponding ones of the plurality of loads to generate corresponding feedback voltages,
said code generator including a plurality of comparators to respectively receive a feedback voltage of the feedback voltages and a corresponding reference voltage.

5. The SIMO converter of claim 4,
said plurality of comparators to respectively compare the corresponding received feedback voltage and the corresponding reference voltage and, based on the comparison, generate a code indicative of the transient event.

6. The SIMO converter of claim 5,
at least one of said plurality of current sources to compensate for a load variation condition associated with the load transient event,
at least one of said source transistors and sink transistors of at least one of said plurality of sources to receive the code and to activate based on the transient event.

7. The SIMO converter of claim 6,
said load variation condition including at least one of voltage overshoot, voltage undershoot, or cross-regulation.

8. The SIMO converter of claim 5,
said plurality of comparators respectively electrically connected to gate terminals of the source transistors and sink transistors of the plurality of current sources,
said plurality of current sources to compensate for a load variation condition associated with the load transient event,
said source transistors and sink transistors of at least one of said plurality of current sources to receive the code from corresponding comparators of the plurality of comparators, the code being indicative of the transient event.

9. The SIMO converter of claim 8,
wherein said load variation condition is voltage overshoot,
said code to sequentially activate said sink transistors of corresponding ones of the plurality of current sources.

10. The SIMO converter of claim 8,
wherein said load variation condition is voltage undershoot,
said code to sequentially activate said source transistors of corresponding ones of the plurality of current sources.

11. The SIMO converter of claim 8,
wherein said load variation condition is cross-regulation,
said code to sequentially activate said source transistors of corresponding ones of the plurality of current sources and to sequentially activate said sink transistors of corresponding ones of the plurality of current sources.

12. A transient enhancement loop (TEL) circuit, comprising:
one or more input terminals to receive a plurality of reference voltages and a plurality of respective feedback voltages;
a plurality output terminals electrically connected to corresponding ones of a plurality of loads, said feedback voltages respectively corresponding to respective voltages supplied to the plurality of loads;
a code generator including a plurality of comparators, said plurality of comparators to compare respective ones of the plurality of reference voltages and respective ones of the plurality of feedback voltages, detect a load transient event associated with one or more of the loads based on the comparison, and generate a code indicative of the load transient event; and
a plurality of current sources to compensate for a load variation condition caused by the load transient event, said plurality of current sources respectively including respective source transistors and respective sink transistors electrically connected between respective ones of the output terminals of the plurality of output switches and corresponding ones of the plurality of loads, said respective source transistors being electrically connected to a source voltage and to supply additional current to corresponding ones of the plurality of loads, said respective sink transistors being electrically connected to a ground terminal and to reduce an amount of current supplied to corresponding ones of the plurality of loads.

13. The TEL circuit of claim 12,
said plurality of comparators corresponding respectively to the plurality of current sources, the plurality of comparators respectively electrically connected to respective gate terminals of the corresponding source transistors and sink transistors,
said source transistors and sink transistors of at least one of said plurality of current sources to receive the code, the code being indicative of the transient event.

14. The TEL circuit of claim 13,
wherein said load variation condition is voltage overshoot,
said code to sequentially activate said sink transistors of corresponding ones of the plurality of current sources.

15. The SIMO converter of claim 13,
wherein said load variation condition is voltage undershoot,
said code to sequentially activate said source transistors of corresponding ones of the plurality of current sources.

16. The SIMO converter of claim 13,
wherein said load variation condition is cross-regulation,
said code to sequentially activate said source transistors of corresponding ones of the plurality of current sources and to sequentially activate said sink transistors of corresponding ones of the plurality of current sources.

17. A method for operating a single inductor multiple output (SIMO) converter, comprising:
sampling, by a transient enhancement loop (TEL), a plurality output voltages between a plurality of output switches and corresponding loads electrically connected to respective output terminals of the plurality of switches;
detecting, by the TEL, a load transient event associated with one or more of the loads;
generating, by a code generator of the TEL, a code indicative of the load transient event; and
activating at least one of a plurality of current sources of the TEL based on the code, said plurality of current sources including respective source transistors and respective sink transistors electrically connected to respective ones of the output terminals of the plurality of output switches, said respective source transistors being electrically connected to a source voltage, said respective sink transistors being electrically connected to a ground terminal.

18. The method of claim 13, wherein detecting, by the TEL, the transient event includes—
receiving, by the TEL, respective reference voltages,
generating, by the TEL, respective feedback voltages from the sampled output voltages.

19. The method of claim 18, wherein generating, by the code generator of the TEL, the code includes—
comparing, by a plurality of comparators of the code generator, the respective feedback voltages and respective reference voltages,
generating, by the plurality of comparators, the code based on the comparison.

20. The method of claim 17, wherein activating the plurality of current sources of the TEL includes—
sequentially activating, based on the code, the source transistors of corresponding ones of the plurality of current sources,
sequentially activating, based on the code, the sink transistors of corresponding ones of the plurality of current sources.
